(19) United States
(12) Patent Application Publication
(10) Pub. No.: US 2024/0105151 A1
(43) Pub. Date: Mar. 28, 2024

(54) Automatic musician assistance

(71) Applicant: Yousician Oy, Helsinki (FI)

(72) Inventors: Sakari BERGEN, Helsinki (FI); Anssi KLAPURI, Espoo (FI); Jarmo HIIPAKKA, Espoo (FI); Christoph THÜR, Helsinki (FI)

(21) Appl. No.: 18/475,278

(22) Filed: Sep. 27, 2023

(30) Foreign Application Priority Data
Sep. 28, 2022 (FI) 20225847

(51) Int. Cl. G10H 1/00; G10G 1/00; G10H 1/36

(52) U.S. Cl. CPC G10H 1/0008; G10G 1/00; G10H 1/361; G10H 2210/005; G10H 2210/381; G10H 2220/116; G10H 2220/395; G10H 2240/325

(57) ABSTRACT

A method and apparatus for presenting at least a portion of a musical notation of a starting point of a song to a user, including a first note or chord to be played; indicating a tempo of the song to the user; receiving from a musical instrument played a signal indicating how the musical instrument is being played; monitoring triggers and responsively to detecting a starting trigger beginning to playback one or more backing tracks; detecting the starting trigger by determining that the user has provided a starting sign independent of the apparatus; and synchronizing the playback of the one or more backing tracks using a time when the user has provided the starting sign.

### TECHNICAL FIELD

The present disclosure generally relates to automatic assistance of a musician. The disclosure relates particularly, though not exclusively, to automatic presentation of music documents and/or backing tracks for a musician.

### BACKGROUND

This section illustrates useful background information without admission of any technique described herein representative of the state of the art.

A variety of systems exist for presenting notes or chords and playing backing tracks for a musician. For example, a musician can start a music document and backing track application to run through a song and play along using the music document, e.g., chords or notes thereof. In order to allow the musician to play along from the very start of the song, playback can be started with some lead period that visually indicates when the playing should begin.

On playing music, the musician should produce correct notes or chords at correct times. For identifying the correct times, the musicians often count in their mind or aloud at least before starting to play so as to acquire a joint rhythm. In case of an automatic musician assistance, the correct rhythm may be indicated with a metronome that clicks during the lead period so that the musician can start playing along in synchrony with the automatic assistance. Possible backing tracks are then also synchronously played back and the playing sounds and feels good. However, the musician then has to start playing at the time as scheduled by the automatic assistance. Moreover, the musician cannot rehearse starting to play with a correct rhythm without an audible metronome clicking.

It is an object of the present document to avoid or alleviate these problems or at least to provide a new technical alternative. A user interface that removes the need for a user to touch or manually operate any keys or buttons may mitigate the need to put a musical instrument aside or remove hands from an intended playing position, e.g., on a fret board or from a wind instrument.

### SUMMARY

The appended claims define the scope of protection. Any examples and technical descriptions of apparatuses, products and/or methods in the description and/or drawings not covered by the claims are presented not as embodiments of the invention but as background art or examples useful for understanding the invention.

According to a first example aspect there is provided a method in an apparatus, the method comprising
presenting at least a portion of a musical notation of a starting point of a song to a user, including a first note or chord to be played;
indicating a tempo of the song to the user;
receiving from a musical instrument played a signal indicating how the musical instrument is being played;
monitoring triggers and responsively to detecting a starting trigger:
   beginning to playback one or more backing tracks;
   the method further comprising:
   detecting the starting trigger by determining that the user has provided a starting sign independent of the apparatus; and
   synchronizing the playback of the one or more backing tracks using a time when the user has provided the starting sign.

The method may comprise displaying a portion of the musical notation for a current or immediately following part of the song, in response to the detecting of the starting trigger. The method may comprise tracking progress of the song and responsively continuing the playback and displaying of the musical notation to enable the user to play the musical instrument accordingly.

The starting sign independent of the apparatus may be playing of the first note or chord. The starting sign may comprise an audible sign such as clapping a hand or tapping on the musical instrument. The starting sign may be received by speech recognition. The starting sign may be a spoken command. The starting sign may be issued by spoken counting. The starting sign may be visual. The starting sign may be a gesture of the user. The starting sign may be detected from a camera image signal. The starting sign may be detected using an acceleration sensor of an accessory device, such as a mobile phone or a smart watch.

The synchronizing may be aligned with the time when the user has played the first note or chord.

The method may further comprise presenting a metronome click to the user, at least auditively, visually, or haptically. The metronome click may be haptically presented to the user using a vibrator of a mobile phone, smart watch, or a dedicated device. The metronome click may be visually presented to the user by blinking a symbol on a screen at the rate of the tempo. The symbol being blinked may be or comprise a first note or chord to be played. The symbol being blinked may be or comprise a region surrounding the first note or chord to be played, such as a highlighted region surrounding the first note or chord to be played.

The synchronizing may be aligned with a metronome tick that is temporally closest to the time when the user has played the first note or chord. Further alternatively, the synchronizing may be aligned with the metronome tick that is temporally closest to the time when the user has played the first note or chord if a temporal distance to the closest metronome tick falls below a given threshold and alternatively aligning the synchronizing with the time when the user has played the first note or chord and synchronizing the metronome with that time.

The time when the user played the first note or chord may be defined from a beginning of the first note or chord. In case that the first chord is played as a progression of notes, e.g., as arpeggio, the beginning of the first chord may be defined as a start of the first note that forms the first chord.

The synchronizing may compensate for acoustic and/or electric delays in the detecting of the starting trigger. The synchronization may compensate for an acoustic propagation delay of sound in the air from an acoustic metronome click producer to the user. The synchronization may compensate for an acoustic propagation delay of sound in the air from the user to the apparatus. The synchronization may compensate for a processing delay in the apparatus. The processing delay may comprise a time required for waiting to identify whether the current chord is being formed of a succession of parts, e.g., as arpeggio. The compensation may be configured to cause the playback of the one or more backing tracks with a timing advance adapted to compensate for latencies of signal transfer from the musical instrument to the apparatus and from the playback of the one or more backing tracks to the user. The method may adapt to a channel over which the signal is received from the musical instrument so that an acoustic channel is compensated for estimated acoustic sound propagation and subsequent electric processing delays and an electric channel is compensated for by electric signal propagation and processing delays. The method may comprise allowing the user to adjust a time offset for the one or more backing tracks to electrically simulate a spatially distributed orchestra. The method may comprise automatically determining the latency by determining a time offset between a movement of the user or a hand of the user and a corresponding change in the signal received from the musical instrument.

The presenting of the at least portion of the musical notation may comprise displaying one or more notes or chords. The presenting of the at least portion of the musical notation may comprise providing an auditive indication of one or more notes or chords. The auditive indication may comprise playing the one or more notes or chords. The auditive indicating of the one or more notes or chords may comprise indicating the one or more notes or chords by a spoken output.

The starting point may reside at a start of the song. The user may be allowed to select the starting point from within the song. The starting point may represent a note or chord selected by the user.

The starting trigger may comprise the starting sign provided within a maximum temporal distance from the metronome tick. Any signs provided by the user may be discarded as the starting sign if not issued within the maximum temporal distance.

The method may comprise allowing the user to adjust the tempo. An indication of a tempo adjustment may be received using a touch screen, e.g., with a slider presented on the touch screen. An indication of a tempo adjustment may be received remotely from the user, e.g., without requiring the user to use any controls of the apparatus. An indication of a tempo adjustment may be received using speech recognition and detecting the tempo from a counting spoken by the user. An indication of a tempo adjustment may be received by capturing a pace with which the user taps the musical instrument, or an accessory device equipped with an acceleration sensor. The user adjusted tempo may be stored as a new default for the song.

The method may comprise selecting the song from a group of songs. The selection of the song may be performed by the apparatus. Alternatively, the selection of the song may be received from the user.

The presenting of the metronome click may be stopped or attenuated while the user is playing the song.

The method may further comprise detecting that the user has provided a stopping sign independent of the apparatus; and responsively stopping the playback of the one or more backing tracks.

The stopping sign may be or comprise the user stopping the playing of the musical instrument. The stopping sign may comprise an audible sign such as clapping a hand or tapping on the musical instrument. The stopping sign may be received by speech recognition. The stopping sign may be a spoken command. The stopping sign may be issued by spoken counting. The stopping sign may be visual. The stopping sign may be a gesture of the user. The stopping sign may be detected from a camera image signal. The stopping sign may be detected using an acceleration sensor of an accessory device, such as a mobile phone or a smart watch. The stopping sign may comprise first stopping the playing and the audible sign, spoken command, a visual sign, or a signal using the acceleration sensor.

The monitoring of the triggers may detect if a starting sign is provided by the user. The monitoring may be stopped on detecting the starting sign. Alternatively, the monitoring of the triggers may be continued for detecting if a stopping sign is provided by the user after the starting sign.

The method may comprise detecting that the user has stopped playing and defining a new starting point based on the point at which the playing was stopped. The new starting point may be positioned to a beginning of a measure during which the playing was stopped. The metronome click may be resumed on defining the new starting point.

The playback of the backing tracks may be adapted to start one or more vocals track from the beginning of a next phrase.

According to a second example aspect there is provided an apparatus comprising at least one memory and processor collectively configured to cause the apparatus to perform the method of the first example aspect.

The apparatus may be or comprise a smart phone. The apparatus may be or comprise a portable computer. The apparatus may be or comprise a tablet computer. The apparatus may be or comprise a smart watch. The apparatus may be or comprise a smart television. The apparatus may be or comprise a laptop computer. The apparatus may be or comprise an electronic game device. The apparatus may be dedicated for performing the method of the first example aspect.

The apparatus may comprise a microphone for receiving signals representing the playing of the instrument and/or audible trigger indicia from the user. The apparatus may comprise a MIDI input for receiving signals representing the playing of the instrument. The apparatus may comprise a display for displaying musical instructions for the user. The apparatus may comprise a loudspeaker for audible presentation of at least some of the backing tracks. The apparatus may comprise a microphone input for electrically receiving sound from the user and/or the musical instrument. The apparatus may comprise a wireless interface for co-operating with one or more other apparatuses. The apparatus may be configured to allow the user to select an instrument from a plurality of different instruments. The apparatus may be configured to display the musical instructions for the selected musical instrument. The apparatus may be further configured to display musical instructions for one or more other instruments to help the user to follow progress of the song during periods when the user is not supposed to play her musical instrument. The apparatus may be configured to display lyrics of the song being played or a current portion of the lyrics of the song being played to help the user to follow the progress of the song.

A vocal tract and/or a mouth of the user may be a musical instrument for singing or playing acapella music.

According to a third example aspect there is provided a computer program comprising computer executable program code which when executed by at least one processor causes an apparatus at least to perform:

According to a fourth example aspect there is provided a computer program product comprising a non-transitory computer readable medium having the computer program of the third example aspect stored thereon.

According to a fifth example aspect there is provided an apparatus comprising means for performing the method of any preceding aspect.

Any foregoing memory medium may comprise a digital data storage such as a data disc or diskette; optical storage; magnetic storage; holographic storage; opto-magnetic storage; phase-change memory; resistive random-access memory; magnetic random-access memory; solid-electrolyte memory; ferroelectric random-access memory; organic memory;

or polymer memory. The memory medium may be formed into a device without other substantial functions than storing memory or it may be formed as part of a device with other functions, including but not limited to a memory of a computer; a chip set; and a sub assembly of an electronic device.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 schematically shows a system according to an example embodiment;

FIG. 2 shows a screenshot of an example embodiment;

FIG. 3 shows a block diagram of an apparatus according to an example embodiment; and

FIG. 4 shows a flow chart according to an example embodiment.

### DETAILED DESCRIPTION

In the following description, like reference signs denote like elements or steps.

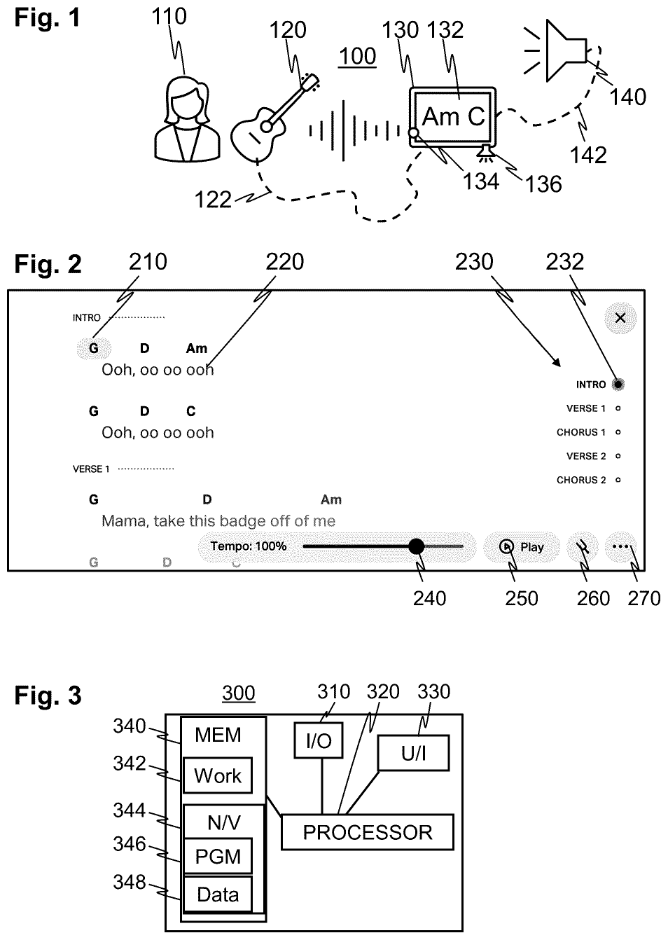

FIG. 1 schematically shows a user 110 and a system 100 according to an example embodiment. The system comprises a musical instrument 120, here a guitar; an apparatus 130 such as a tablet computer or a smartphone; and a loudspeaker 140. FIG. 1 further shows an optional electric cable 122 such as an analogue guitar cable, microphone cable, or a MIDI cable; a built-in or attachable microphone 134; a built-in or attachable loudspeaker 136; and an external loudspeaker 140 with an optional loudspeaker cable. In an example embodiment, system 100 comprises a plurality of microphones, e.g., one or more for each musical instrument. In an example embodiment, the system 100 comprises a plurality of loudspeakers 136, 140. The loudspeakers may be wired and/or wireless.

FIG. 2 shows a screenshot of an example embodiment. The screenshot illustrates a blinking metronome tick 210 region surrounding one of a plurality of chords, at a given starting point of a current song. The starting point is here selected from a plurality of song structure parts 230, e.g., by tapping a respective soft button on a touch screen or by using speech recognition, e.g., by recognizing the user having said the name of the structural part in question.

FIG. 2 further shows a tempo slider 240, a soft play button 250, a soft tuner button 260, and a soft options button 270, as well as a plurality of subsequent chords and lyrics following the starting point. FIG. 2 additionally shows together with the chords and the lyrics the respective names of structural parts, here INTRO and VERSE 1 so as to facilitate perception of a current song position on playing the song.

FIG. 2 merely illustrates one example. It is understood that other example embodiments may differ at least in the controls shown and/or the layout of the screen. However, FIG. 2 helps to understand some features of various example embodiments described in the following.

Before describing various operations, let us review how the apparatus 130 may be implemented. As mentioned, the apparatus 130 may be a smartphone or a tablet computer, with a structure known from these. There are also various other devices that can be used to implement the apparatus 130. FIG. 3 depicts a block diagram of a generalized form of the apparatus 130 according to an example embodiment. The apparatus 130 comprises a communication interface 310; a processor 320; a user interface 330; and a memory 340.

The communication interface 310 comprises in an embodiment a wired and/or wireless communication circuitry, such as Ethernet; Wireless LAN; Bluetooth; GSM; CDMA; WCDMA; LTE; and/or 5G circuitry. The communication interface can be integrated in the apparatus 130 or provided as a part of an adapter, card or the like, that is attachable to the apparatus 130. The communication interface 310 may support one or more different communication technologies. The apparatus 130 may also or alternatively comprise more than one of the communication interfaces 310.

In this document, a processor may refer to a central processing unit (CPU); a microprocessor; a digital signal processor (DSP); a graphics processing unit; an application specific integrated circuit (ASIC); a field programmable gate array; a microcontroller; or a combination of such elements.

The user interface may comprise a circuitry for receiving input from a user of the apparatus 130, e.g., via a keyboard; graphical user interface shown on the display of the apparatus 130; speech recognition circuitry; or an accessory device; such as a headset; and for providing output to the user via, e.g., a graphical user interface or a loudspeaker.

The memory 340 comprises a work memory 342 and a persistent memory 344 configured to store computer program code 346 and data 348. The memory 340 may comprise any one or more of: a read-only memory (ROM); a programmable read-only memory (PROM); an erasable programmable read-only memory (EPROM); a random-access memory (RAM); a flash memory; a data disk; an optical storage; a magnetic storage; a smart card; a solid-state drive (SSD); or the like. The apparatus 130 may comprise a plurality of the memories 340. The memory 340 may be constructed as a part of the apparatus 130 or as an attachment to be inserted into a slot; port; or the like of the apparatus 130 by a user or by another person or by a robot. The memory 340 may serve the sole purpose of storing data or be constructed as a part of an apparatus 130 serving other purposes, such as processing data.

A skilled person appreciates that in addition to the elements shown in FIG. 3, the apparatus 130 may comprise other elements, such as microphones; displays; as well as additional circuitry such as input/output (I/O) circuitry; memory chips; application-specific integrated circuits (ASIC); processing circuitry for specific purposes such as source coding/decoding circuitry; channel coding/decoding circuitry; ciphering/deciphering circuitry; and the like. Additionally, the apparatus 130 may comprise a disposable or rechargeable battery (not shown) for powering the apparatus 130 if external power supply is not available.

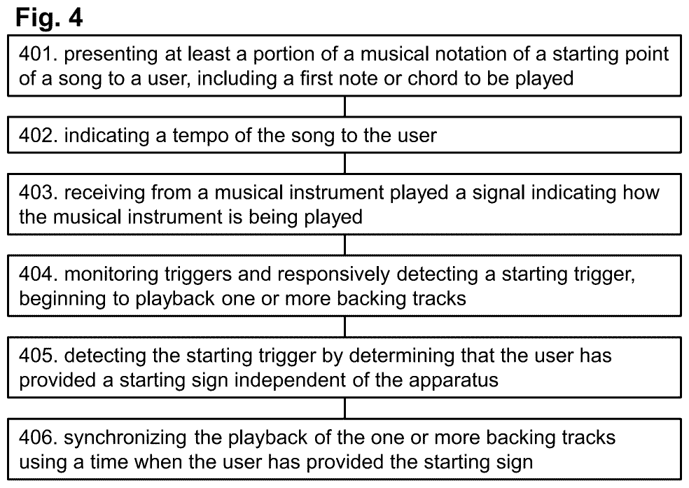

FIG. 4 shows a flow chart according to an example embodiment, illustrating a method in an apparatus. The method comprises 401 presenting at least a portion of a musical notation of a starting point of a song to a user, including a first note or chord to be played. In an example embodiment, the presenting of the at least portion of the musical notation comprises displaying one or more notes or chords, and/or providing an auditive indication of one or more notes or chords. The auditive indication comprises in an example embodiment playing the one or more notes or chords and/or indicating the one or more notes or chords by a spoken output.

A tempo of the song is indicated 402 to the user. In an example embodiment, a metronome click is presented to the user, at least auditively, visually, or haptically. The metronome click can be presented to the user haptically using a vibrator of a mobile phone, smart watch, or a dedicated device. For example, the operation of such a device can be controlled using wirelessly transmitted information from the apparatus to such a device. Alternatively, or additionally, a metronome click is presented to the user visually by blinking a symbol on a screen at the rate of the tempo. In an example embodiment, the symbol being blinked is or comprises a first note or chord to be played and/or a region surrounding of the first note or chord to be played, such as a highlighted region surrounding the first note or chord to be played.

A signal is received 403 from a musical instrument played a signal indicating how the musical instrument is being played. In an example embodiment, the signal is received by a microphone signal representing the playing of the instrument. The microphone may be further or alternatively used for receiving audible trigger indicia from the user. In an example embodiment, the signal is received by a MIDI input for signals representing the playing of the instrument.

In step 404, triggers are monitored and responsively a starting trigger is detected, beginning to play one or more backing tracks. In an example embodiment, on the monitoring of the triggers, it is detected if the starting sign is provided by the user and if yes, the monitoring is stopped on detecting the starting sign or continued for detecting if the stopping sign is provided by the user after the starting sign. After detecting the stopping sign, the monitoring may change to detecting if the starting sign is issued by the user.

In an example embodiment, the detecting of the starting sign is performed independently of the apparatus by detecting playing of the first note or chord. The playing of the first note or chord may be detected from the signal indicating how the musical instrument is being played. In an example embodiment, the starting sign comprises an audible sign such as clapping a hand or tapping on the musical instrument. In an example embodiment, the starting sign is received by speech recognition; wherein the starting sign may be a spoken command and/or the starting sign may be issued by spoken counting. In an example embodiment, a visual starting sign given by the user is detected. The visual starting sign may be a gesture of the user. In an example embodiment, the visual starting sign is detected from a camera image signal. In an example embodiment, the starting sign is detected using an acceleration sensor of an accessory device, such as a mobile phone or a smart watch. In an example embodiment, the user is informed of the starting sign or possible starting signs so as to simplify use of the apparatus. For example, the apparatus can be configured to inform the user of the starting sign by spoken and/or displayed instructions.

In an example embodiment, the starting trigger is detected 405 by determining that the user has provided a starting sign independent of the apparatus. In an example embodiment, the defining the starting trigger requires that the starting sign be provided within a maximum temporal distance from the metronome tick. Any signs provided by the user as the starting sign may be discarded if not issued within the maximum temporal distance.

In an example embodiment, the playback of the one or more backing tracks is synchronized 406 using a time when the user has provided the starting sign. In an example embodiment, the synchronizing is aligned with the time when the user has played the first note or chord. In an alternative example embodiment, the synchronizing is aligned with a metronome tick that is temporally closest to the time when the user has played the first note or chord. This may be conditional to a temporal distance to the closest metronome tick falling below a given threshold, and that failing aligning the synchronizing with the time when the user has played the first note or chord and synchronizing the metronome with that time. In an example embodiment, the time when the user played the first note or chord is defined from a beginning of the first note or chord.

In an example embodiment, the synchronizing compensates for acoustic and/or electric delays in the detecting of the starting trigger for aligning the backing track more accurately. This may involve compensating for an acoustic propagation delay of sound in the air from an acoustic metronome click producer to the user, and/or compensating for an acoustic propagation delay of sound in the air from the user to the apparatus; and/or compensating for a processing delay in the apparatus. The processing delay may comprise a time required for waiting to identify whether the current chord is being formed of a succession of parts. In an example embodiment, the compensation comprises causing the playback of the one or more backing tracks with a timing advance adapted to compensate for latencies of signal transfer from the musical instrument to the apparatus and from the playback of the one or more backing tracks to the user. In an example embodiment, the compensation is adapted to a channel over which the signal is received from the musical instrument so that an acoustic channel is compensated for estimated acoustic sound propagation and subsequent electric processing delays and an electric channel is compensated for by electric signal propagation and processing delays. For the acoustic sound propagation, a latency is determined in an example embodiment by determining a time offset between a movement of the user or a hand of the user and a corresponding change in the signal received from the musical instrument. In an example embodiment, the user is allowed to adjust a time offset for the one or more backing tracks to electrically simulate a spatially distributed orchestra.

In an example embodiment, the starting point is defined to be at a start of the song. In an example embodiment, the user is allowed to select the starting point from within the song. In an example embodiment, the starting point is represented by a note or chord selected by the user.

In an example embodiment, a portion of the musical notation is displayed for a current or immediately following part of the song, in response to the detecting of the starting trigger. In an example embodiment, a progress of the song is tracked and responsively the playback is continued, and the musical notation is displayed to enable the user to play the musical instrument accordingly.

In an example embodiment, the user is allowed to adjust the tempo, optionally remotely. For example, an indication of a tempo adjustment can be received using a touch screen, e.g., with a slider presented on the touch screen; and/or an indication of the tempo adjustment can be received using speech recognition and detecting the tempo from a counting spoken by the user. In an example embodiment, an indication of the tempo is received by capturing a pace with which the user taps the musical instrument, or an accessory device equipped with an acceleration sensor. In an example embodiment, the user adjusted tempo is stored as a new default for the song.

In an example embodiment, the song is selected from a group of songs, e.g., by the apparatus and/or using a selection of the song received from the user.

In an example embodiment, the presenting of the metronome click is stopped or attenuated while the user is playing the song and/or while the user is changing settings, tuning the musical instrument, or otherwise operating the apparatus indicating that the user is not at present willing to play the musical instrument.

In an example embodiment, it is detected that the user has provided a stopping sign independent of the apparatus; and responsively the playback of the one or more backing tracks is stopped. In an example embodiment, it is interpreted as the stopping sign that the user has stopped the playing of the musical instrument. In an example embodiment, it is interpreted as the stopping sign that an audible sign such as clapping a hand or tapping on the musical instrument is detected. In an example embodiment, the stopping sign is received by speech recognition, e.g., from a spoken command or spoken counting. In an example embodiment, the stopping sign is visually received, e.g., by detecting a gesture of the user, e.g., from a camera image signal. In an example embodiment, the stopping sign is received using an acceleration sensor of an accessory device, such as a mobile phone or a smart watch. In an example embodiment, the stopping sign is detected by identifying at least the user first stopping the playing and then detecting audible sign, spoken command, a visual sign, and/or detecting a signal using the acceleration sensor.

In an example embodiment, on detecting that the user has stopped playing, a new starting point is defined based on the point at which the playing was stopped. The new starting point may be positioned to a beginning of a measure during which the playing was stopped.

The metronome click is resumed in an example embodiment on defining the new starting point.

On starting the playback of the backing tracks, the playback is adapted in an example embodiment to start one or more vocals track from beginning of a next phrase. Musical instructions are displayed for the user on a display before and during the playing of the musical instrument.

A loudspeaker is used in an example embodiment for audible presentation of at least some of the backing tracks. A wireless interface may be used for co-operating with one or more other apparatuses. In an example embodiment, the user to is allowed select from a plurality of different instruments an instrument, and the musical instructions are displayed only or at least for the selected musical instrument. In an example embodiment, the musical instructions are displayed for one or more other instruments to help the user to follow progress of the song during periods when the user is not supposed to play her musical instrument. In an example embodiment, the lyrics are displayed of the song being played or a current portion of the lyrics of the song being played to help the user to follow the progress of the song.

A technical effect of at least one embodiment is that a user may perform hands-free starting and/or stopping control of the apparatus. This may be particularly useful to support on rehearsing playing chords that require difficult alignment of fingers on a fretboard. Another technical effect of at least one embodiment is that the user may be provided with a target tempo by providing a rhythm reference but not necessitating the user to start playing at any given measure. Hence, the user may freely try out fingering for the first chords before starting to play or directly start playing when ready. When playing in a group, the user may wait until all the players are ready to start and then commence the automatic assistance by playing the first note or chord. Yet another technical effect is that the user may remote control stopping of the automatic assistance at any point on playing the song and resume the assistance without taking her hands off from their playing position on the musical instrument.

Any of the afore-described methods, method steps, or combinations thereof, may be controlled or performed using hardware; software; firmware; or any combination thereof. The software and/or hardware may be local; distributed; centralized; virtualized; or any combination thereof. Moreover, any form of computing, including computational intelligence, may be used for controlling or performing any of the afore-described methods, method steps, or combinations thereof. Computational intelligence may refer to, for example, any of artificial intelligence; neural networks; fuzzy logics; machine learning; genetic algorithms; evolutionary computation; or any combination thereof.

Various embodiments have been presented. It should be appreciated that in this document, words comprise; include; and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A method in an apparatus, the method comprising
presenting at least a portion of a musical notation of a starting point of a song to a user, including a first note or chord to be played;
indicating a tempo of the song to the user;
receiving from a musical instrument played a signal indicating how the musical instrument is being played;
monitoring triggers and responsively to detecting a starting trigger:
beginning to playback one or more backing tracks;
the method further comprising:
detecting the starting trigger by determining that the user has provided a starting sign independent of the apparatus; and
synchronizing the playback of the one or more backing tracks using a time when the user has provided the starting sign.

2. The method of claim 1, further comprising displaying a portion of the musical notation for a current or immediately following part of the song, in response to the detecting of the starting trigger.

3. The method of claim 1, further comprising tracking progress of the song and responsively continuing the playback and displaying of the musical notation to enable the user to play the musical instrument accordingly.

4. The method of claim 1, wherein the starting sign independent of the apparatus is playing of the first note or chord, and the method further comprises detecting the starting sign based on the signal indicating that how the musical instrument is being played.

5. The method of claim 1, wherein the starting sign comprises an audible or visual sign given by the user.

6. The method of claim 1, wherein the starting sign is received using an acceleration sensor of an accessory device, such as a mobile phone or a smart watch.

7. The method of claim 1, wherein the synchronizing is aligned with the time when the user has played the first note or chord.

8. The method of claim 1, wherein the indicating of the tempo of the song to the user further comprises presenting a metronome click to the user at least auditively, visually, or haptically.

9. The method of claim 8, wherein the synchronizing is aligned with a metronome tick that is temporally closest to the time when the user has played the first note or chord.

10. The method of claim 1, further comprising in the synchronization, compensating for acoustic and/or electric delays in the detecting of the starting trigger.

11. The method of claim 1, wherein in the presenting of the at least portion of the musical notation, displaying one or more notes or chords.

12. The method of claim 1, wherein the starting point resides at a start of the song, or the user is allowed to select the starting point from within the song.

13. The method of claim 1, further comprising allowing the user to remotely adjust the tempo.

14. The method of claim 1, further comprising detecting that the user has provided a stopping sign independent of the apparatus; and responsively stopping the playback of the one or more backing tracks.

15. The method of claim 14, wherein the stopping sign is or comprises the user stopping the playing of the musical instrument, and the method further comprises detecting the stopping sign based on the signal indicating that how the musical instrument is being played.

16. An apparatus comprising at least one memory and processor collectively configured to cause the apparatus to perform at least the following method steps:
presenting at least a portion of a musical notation of a starting point of a song to a user, including a first note or chord to be played;
indicating a tempo of the song to the user;
receiving from a musical instrument played a signal indicating how the musical instrument is being played;
monitoring triggers and responsively to detecting a starting trigger:
beginning to playback one or more backing tracks;
the method further comprising:
detecting the starting trigger by determining that the user has provided a starting sign independent of the apparatus; and
synchronizing the playback of the one or more backing tracks using a time when the user has provided the starting sign.

17. The method of claim 2, further comprising tracking progress of the song and responsively continuing the playback and displaying of the musical notation to enable the user to play the musical instrument accordingly.

18. The method of claim 2, wherein the starting sign independent of the apparatus is playing of the first note or chord, and the method further comprises detecting the starting sign based on the signal indicating that how the musical instrument is being played.

19. The method of claim 3, wherein the starting sign independent of the apparatus is playing of the first note or chord, and the method further comprises detecting the starting sign based on the signal indicating that how the musical instrument is being played.

20. A non-transitory computer readable medium having stored thereon computer executable program code which when executed by at least one processor causes an apparatus at least to perform at least the following method steps:
presenting at least a portion of a musical notation of a starting point of a song to a user, including a first note or chord to be played;
indicating a tempo of the song to the user;
receiving from a musical instrument played a signal indicating how the musical instrument is being played;
monitoring triggers and responsively to detecting a starting trigger:
beginning to playback one or more backing tracks;
the method further comprising:
detecting the starting trigger by determining that the user has provided a starting sign independent of the apparatus; and
synchronizing the playback of the one or more backing tracks using a time when the user has provided the starting sign.
